(19) United States
(12) Patent Application Publication
(10) Pub. No.: US 2009/0278844 A1
(43) Pub. Date: Nov. 12, 2009

(54) METHOD AND APPARATUS FOR ENCODING/DECODING 3D MESH INFORMATION INCLUDING STITCHING INFORMATION

(76) Inventors: Eun Young Chang, Jeollabuk-do (KR); Nam Ho Hur, Daejeon (KR); Jin Woong Kim, Daejeon (KR); Soo In Lee, Daejeon (KR); Euee Seon Jang, Seoul (KR); Sin Wook Lee, Seoul (KR); Jae Bum Jun, Seoul (KR)

Correspondence Address: LADAS & PARRY LLP, 224 SOUTH MICHIGAN AVENUE, SUITE 1600, CHICAGO, IL, 60604, US

(21) Appl. No.: 12/519,206

(22) PCT Filed: Jan. 11, 2007
(86) PCT No.: PCT/KR07/00207

§ 371 Date: Jun. 15, 2009

(51) Int. Cl. G06T 15/00

(52) U.S. Cl. 345/419

(57) ABSTRACT

Provided are encoding and decoding stitching information generated when the 3D mesh model that is the non-manifold or non-orientable model is converted into orientable and manifold models upon encoding the 3D mesh information of the 3D mesh model. The method of encoding 3D mesh information includes the steps of: encoding the 3D mesh information to output an encoded bitstream; encoding stitching information of elements contained in the 3D mesh information, the stitching information having a total number of duplicated original elements and, for each of the duplicated original elements, the duplication number, original-element identification information and duplicated-element identification information; and generating a packet of the bitstream, wherein the encoded stitching information is inserted into the packet.

### TECHNICAL FIELD

The present invention relates to encoding and decoding 3D mesh information, and more particularly, to encoding and decoding stitching information used to restore an original non-manifold/non-orientable model, which has been converted into a manifold and orientable one during the encoding process. If a 3D (“3D”) mesh model is non-manifold or non-orientable, it should be first converted into the manifold and orientable model during the encode process, resulting in duplication of elements (such as vertices and faces) of the original model.

### BACKGROUND ART

Recent years have seen the beginning of widespread use of 3D graphics. However, applications of these complex graphics are still limited because of the enormous amounts of information required for the implementation. 3D mesh information representing a 3D model includes geometric information, inter-vertex connectivity information, and property information, such as color, normal, and texture coordinates. The geometric information includes information about three coordinates of a floating point. The connectivity information is represented by an index list in which three or more vertices form one polygon. For example, if a 32 bit floating point is used to represent the geometric information, 96 bits (12B) are needed to represent single geometric information. That is, a 120 KB memory is required when a 3D mesh model is represented by approximately ten thousand vertices having only the geometric information. A 1.2 MB memory is required when the model is represented by a hundred thousand vertices. Further, since the connectivity information can be overlapped twice or more, a massive memory is required to store a 3D model using a polygonal mesh.

Encoding is needed to solve the problem of the huge amount of information. To this end, a 3D mesh coding (3DMC) scheme adopted as a standard of ISO/IEC (International Organization for Standardization/International Electrotechnical Commission) in the field of MPEG-4 (Moving Picture Expert Group)-SNHC (Synthetic and Natural Hybrid Coding) improves transmission efficiency by encoding/decoding 3D mesh information represented by IndexedFaceSet (IFS) in a Virtual Reality Modeling Language (VRML) file.

FIGS. 1A and 1B respectively illustrate conceptual configurations of conventional 3DMC-based encoding and decoding devices. A 3DMC encoding device 110 includes a topological surgery module 111 for decomposing a 3D mesh model (original model) into two-dimensional mesh structures, a geometric information encoding module 112, a connectivity information encoding module 113, a property information encoding module 114, and an entropy encoding module 115 for collectively compressing encoding results from the encoding modules 112 to 114 to generate a 3DMC bit-stream.

The 3DMC decoding device 120 includes an entropy decoding module 121, a geometric information decoding module 122, a connectivity information decoding module 123, a property information decoding module 124, and a topological synthesis module 125, in order to reconstruct 3D model data from the encoded 3DMC bit-stream.

The 3DMC encoding performed by the above-described 3DMC encoding device 110 includes, as a primary characteristic, a topological surgery operation performed by the topological surgery module 111 to maximize a compression rate. The topological surgery operation is proposed by IBM cooperation and is a decomposition operation in which a 3D model is decomposed into two-dimensional mesh structures by cutting the model along a given cutting edge on the assumption that a given mesh is the same as a sphere in topological geometry. Such operation results in a simple polygonal graph (e.g., a triangle tree (TT) having a binary tree structure composed of a triangular strip) and a vertex graph (VG) representing a path along which the mesh is cut, as an inter-vertex linked structure. However, because the above-described topological surgery operation employs the assumption that a given mesh is the same as a sphere in topological geometry, an original model must be converted into several manifold and orientable models when it is a non-manifold/non-orientable model having a mesh not the same as the sphere in topological geometry. In this conversion process, however, vertices and/or faces are duplicated and increased.

FIGS. 2A and 2B illustrate examples in which when a non-manifold model is converted into two orientable and manifold models, two vertices are duplicated and added. Referring to FIG. 2A, a simple non-manifold model including three faces and five vertices is shown. Referring to FIG. 2B, two vertices “2=5” and “1=6” are duplicated and added as the model is converted into two manifold models. The duplicated element information is called “stitching information.”

The stitching information is required to reconstruct an original non-manifold/non-orientable model (hereinafter, referred to as “non-manifold model”) after 3DMC-encoding and decoding the two manifold models having the seven vertices shown in FIG. 2B. In the above example, the original non-manifold model can be reconstructed by replacing the fifth and sixth vertex information with the second and first vertex information, respectively, using the stitching information of “2=5” and “1=6” and then deleting the fifth and sixth vertex information.

Since the orientable and manifold models generated by 3DMC encoding and decoding processes contain the duplicated vertices and faces, they have different topologies from the original model. In addition, editing, special effects, and the like based on an element basis, such as a vertex or a face, cannot be performed and element order-based animation cannot be applied.

### DISCLOSURE

### Technical Problem

The present invention is directed to a method and apparatus for efficiently encoding and decoding stitching information generated when a non-manifold model is converted into manifold models upon 3DMC encoding.

### Technical Solution

One aspect of the present invention provides a method of encoding 3D mesh information, comprising the steps of: encoding the 3D mesh information to output an encoded bitstream; encoding stitching information of elements contained in the 3D mesh information, the stitching information having a total number of duplicated original elements and, for each of the duplicated original elements, the duplication number, original-element identification information and duplicated-element identification information; and generating a packet of the bitstream, wherein the encoded stitching information is inserted into the packet.

Another aspect of the present invention provides a method of encoding stitching information generated during a non-manifold model data encoding process by converting a non-manifold model to manifold models, the method comprising the steps of: (i) setting a bit number used to encode the stitching information to ┌log₂ N┐ (where, N is a total number of elements including duplicated elements); (ii) encoding the total number of duplicated original elements with the bit number; and (iii) encoding, for each of the duplicated original elements, the duplication number plus one, original-element identification information, and duplicated-element identification information with the bit number.

Still another aspect of the present invention provides an apparatus for encoding 3D mesh information, comprising: means for encoding the 3D mesh information to output an encoded bitstream; means for encoding stitching information of elements contained in the 3D mesh information, the stitching information having a total number of duplicated original elements and, for each of the duplicated original elements, the duplication number, original-element identification information and duplicated-element identification information; and means for generating a packet of the bitstream, where in the encoded stitching information is inserted into the packet.

Yet another aspect of the present invention provides a method of decoding 3D mesh information, comprising the steps of: decoding a 3D mesh information packet to reconstruct original model data; determining whether the packet includes stitching information; if it is determined that the packet includes the stitching information, extracting the stitching information from the packet and decoding the stitching information, the decoded stitching information having a total number of duplicated original elements and, for each of the duplicated original elements, the duplication number, original-element identification information and duplicated-element identification information; and restoring an original non-manifold model based on the reconstructed original model data and the decoded stitching information.

Yet another aspect of the present invention provides an apparatus for decoding 3D mesh information, comprising: means for decoding a 3D mesh information packet to reconstruct original model data; means for extracting the stitching information from the packet and decoding the stitching information, the decoded stitching information having a total number of duplicated original elements and, for each of the duplicated original elements, the duplication number, original-element identification information and duplicated-element identification information; and means for restoring an original non-manifold model based on the reconstructed original model data and the decoded stitching information.

### ADVANTAGEOUS EFFECTS

As described above, according to the present invention, stitching information is represented using the total number of duplicated original elements, the number of duplications of each original element, original-element identification information, and duplicated-element identification information, and is encoded with an identifiable minimal number of bits, thereby efficiently transmitting the stitching information and greatly reducing computational complexity.

### DESCRIPTION OF DRAWINGS

FIGS. 1A and 1B are conceptual configurations of conventional 3DMC-based encoding and decoding devices;

FIGS. 2A and 2B illustrate examples in which when a 3D mesh model, which is a non-manifold or non-orientable model, is converted into two orientable and manifold models, vertices are duplicated and added.

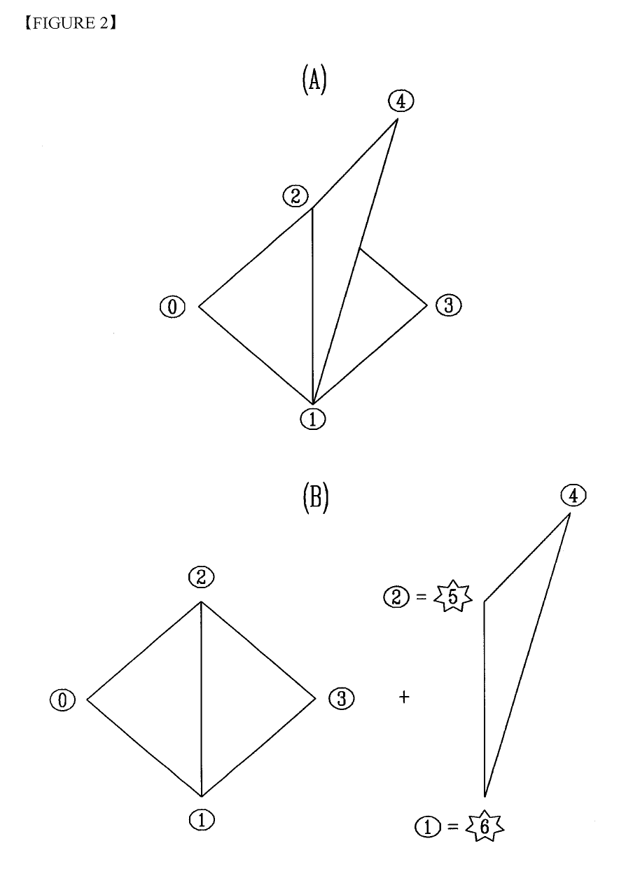

FIGS. 3A and 3B are schematic block diagrams of a 3DMC encoding device 310 and a 3DMC-decoding device 320 according to the present invention;

FIG. 4 is a flowchart illustrating a 3D mesh information encoding process according to an exemplary embodiment of the present invention;

FIG. 5 is a flowchart illustrating a 3D mesh information decoding process according to an exemplary embodiment of the present invention;

FIG. 6 is a flowchart illustrating a process of encoding stitching information according to an exemplary embodiment of the present invention;

FIG. 7 is a flowchart illustrating a process of decoding stitching information according to an exemplary embodiment of the present invention;

FIG. 8 illustrates an example of a 3DMC packet structure having added vertex/face stitching information according to the present invention; and

FIGS. 9A and 9B illustrate an example of syntax of vertex/face stitching information inserted into a packet according to the present invention.

### MODE FOR INVENTION

Hereinafter, an exemplary embodiment of the present invention will be described in detail. However, the present invention is not limited to the exemplary embodiment disclosed below, but can be implemented in various modified forms. Therefore, the present exemplary embodiment is provided for a complete disclosure of the invention which is fully enabling to those of ordinary skill in the art.

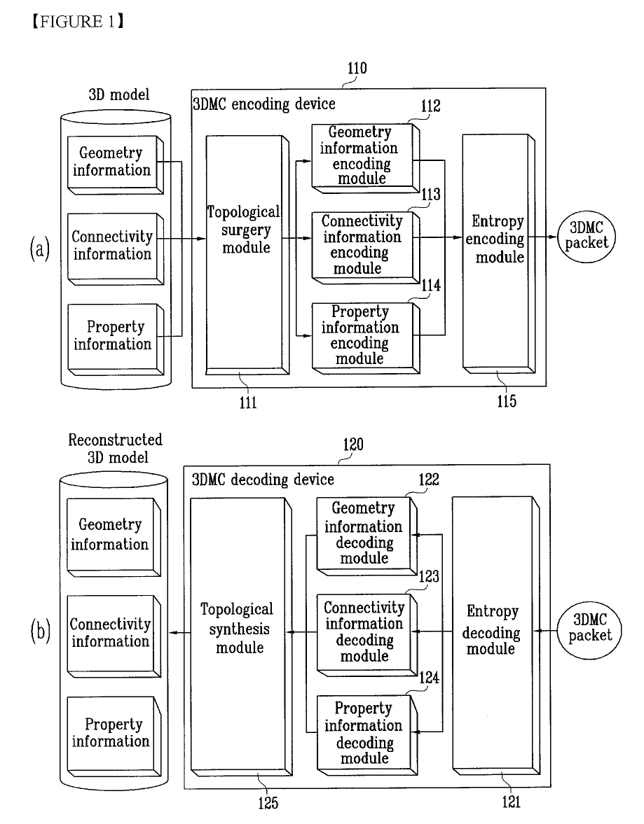

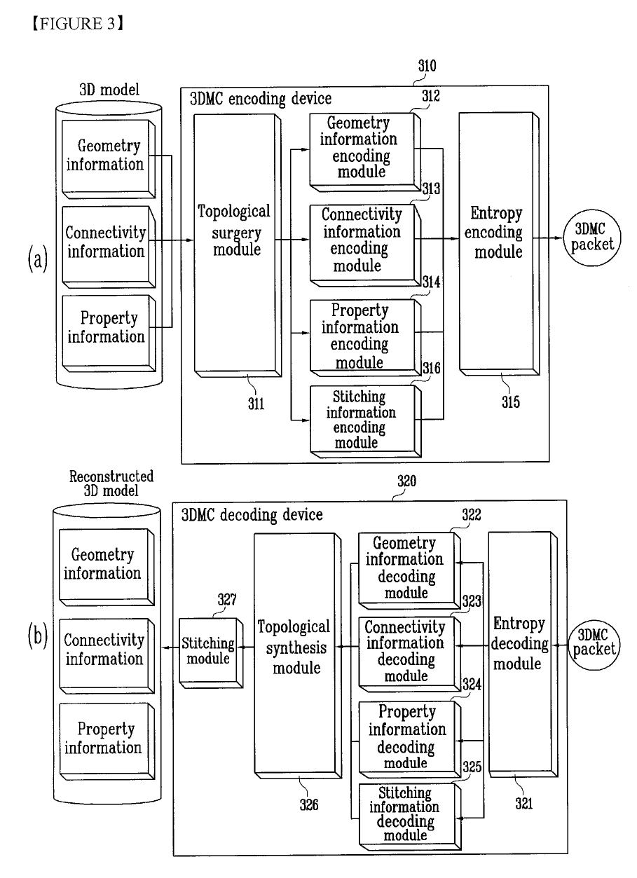

FIGS. 3A and 3B are schematic block diagrams illustrating a 3D mesh information encoding device 310 and a 3D mesh information decoding device 320 according to the present invention. Referring to FIG. 3A, the 3D mesh information encoding device 310 according to the present invention includes a topological surgery module 311, a geometric information encoding module 312, a connectivity information encoding module 313, a property information encoding module 314, a stitching information encoding module 316, and an entropy encoding module 315. In other words, the encoding device 310 is characterized by further including the stitching information encoding module 316 for separately encoding the stitching information in a 3D model, unlike the conventional 3DMC encoding device 110 shown in FIG. 1A.

As previously described, the topological surgery module 311 performs a topological surgery operation in which a 3D mesh model is decomposed into two-dimensional mesh structures. When the 3D mesh model is a non-manifold model, it may be converted into several manifold models. The conversion of the non-manifold model into the manifold models is known as a primary feature of MPEG-4 3D mesh coding and accordingly will not be described herein.

Information relating to elements (vertices and faces) duplicated in the conversion from the non-manifold model into the manifold models is called “stitching information”. Stitching information is required to reconstruct an original non-manifold model after decoding a 3DMC encoded bit-stream in a decoding unit. Using the stitching information, the duplicated elements are deleted and replaced with the original element information so that the original non-manifold model is reconstructed.

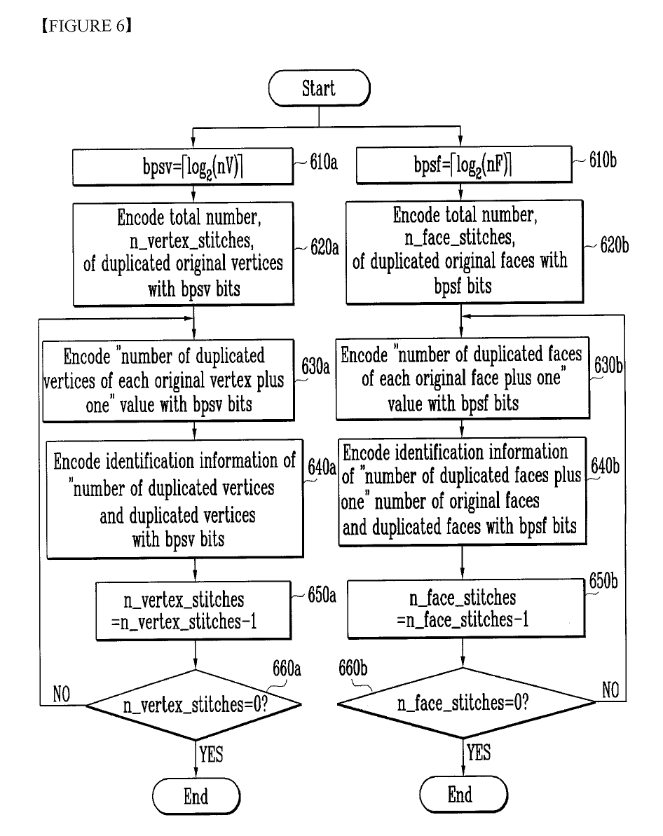

The stitching information encoding module 316 is for encoding the stitching information with an identifiable minimal number of bits according to the present invention. An encoding process will be described in detail with reference to FIG. 6.

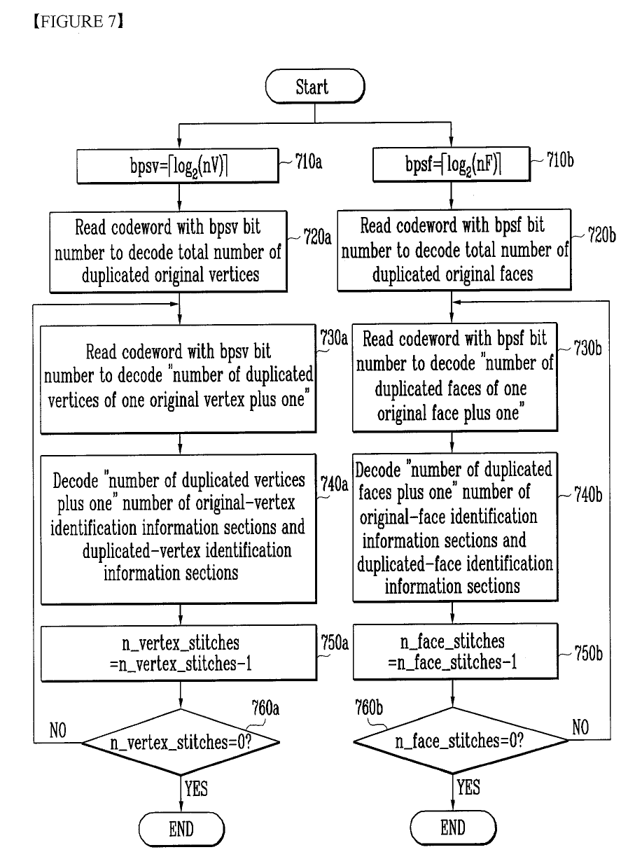

Meanwhile, the 3D mesh information decoding device 320 according to the present invention further includes a stitching information decoding module 325 for decoding encoded stitching information, and a stitching module 327 for restoring an original non-manifold model using the stitching information of the decoded original model, unlike the conventional 3DMC decoding device 320 shown in FIG. 1B. A stitching information decoding process performed by the stitching information decoding module 325 according to the present invention will be described in detail with reference to FIG. 7.

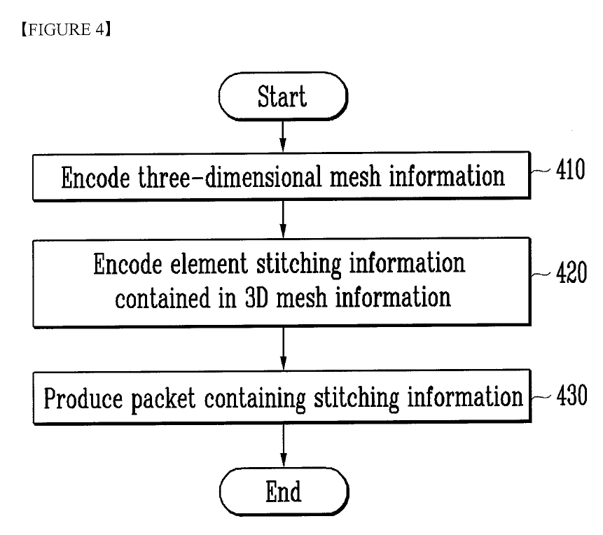

FIG. 4 is a flowchart illustrating a 3D mesh information encoding process according to an exemplary embodiment of the present invention. Referring to FIG. 4, in step 410, 3D mesh information is encoded to generate an encoded bit-stream. According to a conventional SNHC 3DMC encoding scheme, the 3D mesh information is generated by decomposing a 3D mesh model into two-dimensional mesh structures (using topological surgery operation), and includes a vertex graph (VG) and a triangle tree (TT) in a binary tree structure.

The present invention is not characterized by encoding the 3D mesh information itself. It is characterized by representing and encoding stitching information, which is generated when a non-manifold 3D mesh model is converted into manifold models. It will be appreciated by those skilled in the art that the present invention may be applied to all conventional encoding schemes of generating the stitching information, similar to the 3DMC encoding.

In step 420, the element stitching information generated during the 3DMC encoding process of step 410 is encoded. The element stitching information is information on duplicated vertices and/or faces, and may selectively includes vertex stitching information or face stitching information or stitching information for both of them.

The present invention is characterized in that the stitching information includes a total number of duplicated original elements, the number of duplications of each original element, original-element identification information, and duplicated-element identification information, and the stitching information is encoded with an identifiable minimal number of bits to decrease an encoding bit rate and computational complexity.

In step 430, a packet of the 3D mesh information bit-stream encoded in step 410 is generated, and the element stitching information encoded in step 420 is inserted into the packet.

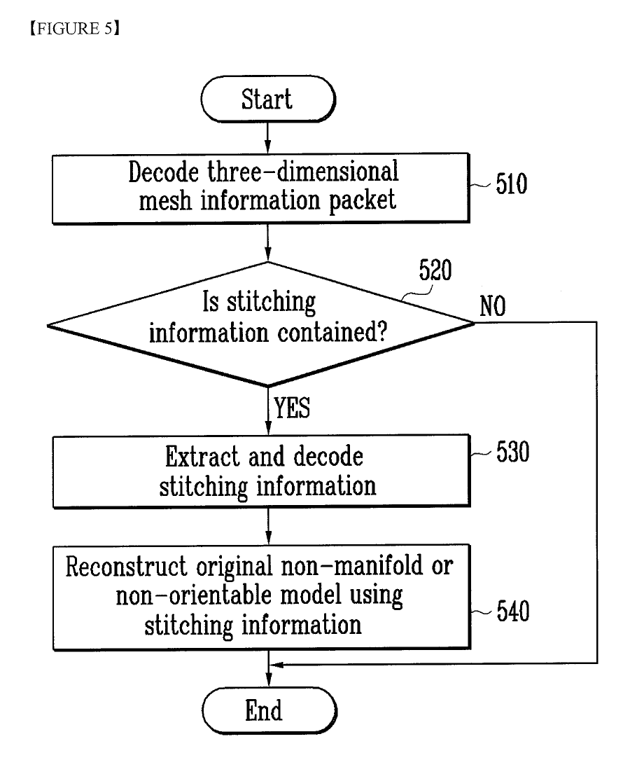

FIG. 5 is a flowchart illustrating a 3D mesh information decoding process according to an exemplary embodiment of the present invention. In step 510, the 3D mesh information packet is decoded. The 3DMC decoding scheme is known in the art and accordingly a detailed description thereof will be omitted.

In step 520, a determination is made as to whether element stitching information is included in a prescribed area (e.g., a header area) of the 3D mesh information packet. When the element stitching information is not included, the decoding process ends.

On the other hand, if it is determined that the element stitching information is included in the received packet, the element stitching information is extracted and decoded in step 530.

In step 540, the original non-manifold model is reconstructed based on the decoded element stitching information. Specifically, the duplicated element information is deleted from the reconstructed original model and replaced with corresponding original element information to reconstruct the original non-manifold model. Further, in case that the identification information of each element is changed due to the deleted duplicated element information, the 3D mesh information needs to be reconstructed by reflecting this change.

It will be easily appreciated by those skilled in the art that the steps 510 to 540 are not necessarily performed in the above-described order, but in a different order. For example, in another embodiment, the step of determining whether the element stitching information is included (step 520) and the step of extracting and decoding the element stitching information (step 530) may be performed prior to the 3DMC decoding (step 510).

FIG. 6 is a flowchart illustrating a process of encoding stitching information according to an exemplary embodiment of the present invention. It will be easily appreciated by those skilled in the art that although a vertex stitching information encoding process and a face stitching information encoding process are shown in FIG. 6 as being both performed, the present invention is not limited thereto but vertex stitching information, face stitching information, or both the vertex and face stitching information may be selectively encoded.

When there is the stitching information for vertices duplicated in the conversion of a non-manifold model into manifold models, first, a codeword bit number assigned to the vertex stitching information, i.e., bits per stitching for vertex (“bpsv”) is set to ┌log₂ (nV)┐ (where, nV indicates a total number of vertices of the model including the duplicated vertices), which is a minimal bit number capable of identifying the vertex stitching information (step 610a). If the original model includes 1,000 vertices and 23 vertices are duplicated in the encoding process, the bpsv value will be log₂ 1023 (=10 bits).

A total number of the duplicated original vertices (“n_vertex_stitches”) is then encoded with the bpsv bits (step 620a). The number of the duplicated vertices plus one for each original vertex (“n_duplication_per_vertex_stitches”) is then encoded with the bpsv bits (step 630a), and identification information of the n_duplication_per_vertex_stitches number of original vertices and the duplicated vertices is also encoded with the bpsv bits (step 640a).

Setting the n_duplication_per_vertex_stitches value to the number of the duplicated vertices plus one in step 630a is only one example, and the present invention is not limited thereto. Alternatively, the value may be set to the number of the duplicated vertices. Setting the value to the number of the duplicated vertices plus one in the above embodiment is for indicating the number of the identification information to be decoded, since the number of the identification information inserted after n_duplication_per_vertex_stitches information is the number of the duplicated vertices plus one.

The number of the duplicated original vertices is then decremented by one (step 650a), and a determination is made as to whether the remaining number of the original vertices is zero (step 660a). Otherwise, the above-described steps 630a and 660a are repeatedly performed to encode the original stitching information for all the vertices.

Meanwhile, in steps 610b to 660b, face stitching information is encoded in the same way as the above-described vertex stitching information encoding steps 610a to 660a, and accordingly, a detailed description thereof will be omitted.

In the embodiment, the codeword bit numbers bpsv and bpsf respectively assigned to the vertex stitching information and the face stitching information in the vertex and face stitching information encoding processes (610a and 610b) are set to the minimal bit number, ┌log₂ (nV)┐ (where, nV indicates a total number of vertices (or faces) of the model including the duplicated vertices (or faces)) capable of identifying the stitching information. However, the present invention is not limited to such an embodiment. It will be easily appreciated by those skilled in the art that the bpsv or bpsf value may be set to a specific bit number, such as 24 bits or 32 bits.

An example in which the element stitching information is encoded according to the present invention will be described. According to the SNHC 3DMC encoding scheme, encoding/decoding is performed in a changed element order, not a VRML-based element order. Accordingly, the identification information of the duplicated vertices and the identification information of the original vertices should be stored in consideration of the changed element order information.

For example, it is assumed that two vertices were duplicated when a non-manifold model including 10 vertices and seven faces is converted into two manifold models and encoded. Because the two vertices are duplicated, actual identification information becomes 0, 1, 2, 3, 4, 5, 6, 7, 8, 9, 10 and 11, in which 10 and 11 indicate the duplicated vertices. The 10-th vertex is duplicated from the 0-th vertex and the 11-th vertex is duplicated from the 3-rd vertex. If the vertex order is not changed, the vertex stitching information is represented and encoded using 0-10 and 3-11 information. However, if the vertex encoding order is changed into 3, 2, 1, 0, 8, 7, 10, 6, 5, 11, 4, 9, the duplicated vertices are encoded fourthly and ninthly, and accordingly actual identification information of the duplicated vertices become 4 and 9, not 10 and 11. Since the 0-th vertex is encoded thirdly and the 3-rd vertex is encoded in the 0-th order, the vertex stitching information is represented and encoded using 3-4 and 0-9 information.

Here, a total number of the duplicated vertices, n_vertex_stitches, becomes 2 and is encoded with 4 bits (=log₂ 12). The number of duplicated vertices of any one of the original vertices is calculated, and then the number plus one is encoded with 4 bits. The identification information of the original vertex and the identification information of the duplicated vertices are then encoded with 4 bits. This process is performed until all the duplicated original vertices are encoded. In this example, if the vertex order is not changed (0-10 and 3-11), “2 2 0 10 2 3 11” is encoded with 4 bits, resulting in “0010 0010 0000 1010 0010 0011 1011”.

FIG. 7 is a flowchart illustrating the process of decoding stitching information according to an exemplary embodiment of the present invention. First, the bit number, “bpsv (bit per stitching for vertex)”, used to encode the vertex stitching information is obtained by Equation 1 (step 710a).

bpsv=┌log₂(nV)┐, Equation 1

where nV indicates a total number of vertices of the model including duplicated vertices.

Equation 1 is of illustrative purpose. In another embodiment, the bit number information may be contained in the encoded stitching information.

The codeword with the bpsv bits is then read from the encoded stitching information bit-stream to decode a total number of the duplicated original vertices, n_vertex_stitches (step 720a). The codeword with the bpsv bits is then read to decode the number of duplications (or the number of the duplicated vertices) of one original vertex plus one, i.e., n_duplication_per_vertex_stitches (step 730a).

Then, the codewords having the bpsv bit number are sequentially read to decode an n_duplication_per_vertex_stitches number of original-vertex identification information and duplicated-vertex identification information (step 740a).

The number of the duplicated original vertices is decremented by one (step 750a). A determination is then made as to whether the remaining number of the original vertices is zero (step 760a). Otherwise, the above-described steps 730a and 760a are repeatedly performed to decode the stitching information of all the original vertices.

Meanwhile, steps 710b to 760b perform face stitching information decoding in the same way as the above-described vertex stitching information decoding steps 710a to 760a and accordingly a detailed description thereof will be omitted.

After the process of decoding the element stitching information ends, the duplicated element information is replaced with the original element information and deleted based on the decoded stitching information to reconstruct the original non-manifold or non-orientable model from more than one orientable and manifold models. For example, in the case of geometry information, the geometry information for the duplicated vertices other than the geometry information for the original vertices are all deleted from the decoded 3D geometry information. In the case of connectivity information, coordIndex values using the identification information of the deleted duplicated vertices are all replaced with the original-vertex identification information. Finally, when the vertex identification information is changed due to the duplicated vertex deletion, the connectivity information should be reconstructed by reflecting this change.

A process in which the original non-manifold or non-orientable model is reconstructed after the element stitching information is decoded according to the present invention will be described by way of example. It is assumed that decoded 3D geometry information, connectivity information, and vertex stitching information are as follows:

```
coord Coordinate {
  point [
−0.0010 −0.0010 0.9980
0.9980 −0.0010 0.9980
0.9980 0.9980 0.9980
−0.0010 0.9980 0.9980
−0.0010 0.9980 −0.0010
−0.0010 −0.0010 −0.0010
0.9980 −0.0010 −0.0010
0.9980 0.9980 −0.0010
0.9980 1.9990 0.9980
0.9980 1.9990 −0.0010
0.9980 0.9980 −0.0010
0.9980 0.9980 0.9980
  ]
}
  coordIndex [
0 1 2 3 −1
0 3 4 5 −1
0 5 6 1 −1
1 6 7 2 −1
2 7 4 3 −1
4 7 6 5 −1
8 9 10 11 −1
  ]
vertex stitching information
7−10, 2−11
```

First, the duplicated-vertex information other than the original-vertex information is deleted and replaced based on the decoded stitching information. The coordIndex using an identifier of the deleted duplicated vertex is replaced with an identifier of the original vertex, thereby obtaining the following result:

```
coord Coordinate {
  point [
−0.0010 −0.0010 0.9980
0.9980 −0.0010 0.9980
0.9980 0.9980 0.9980
−0.0010 0.9980 0.9980
−0.0010 0.9980 −0.0010
−0.0010 −0.0010 −0.0010
0.9980 −0.0010 −0.0010
0.9980 0.9980 −0.0010
0.9980 1.9990 0.9980
0.9980 1.9990 −0.0010
  ]
  }
  coordIndex [
0 1 2 3 −1
0 3 4 5 −1
0 5 6 1 −1
1 6 7 2 −1
2 7 4 3 −1
4 7 6 5 −1
8 9 7 2 −1
  ]
```

When the vertex identification information is changed due to duplicated vertex deletion, i.e., when the identification information is not continuous, the connectivity information should be reconstructed by reflecting this change. In the above example, it is unnecessary to perform the reconstruction since the duplicated vertex is last added. However, when the duplicated vertex is located between the original vertices as encoding/decoding is performed in a changed element order, deletion of the duplicated vertex changes the identification information for each vertex. Accordingly, the identification information change must be reflected to amend the connectivity information. For example, when the duplicated vertex is added between the original vertices, it must be deleted and identification information for subsequent vertices must be modified.

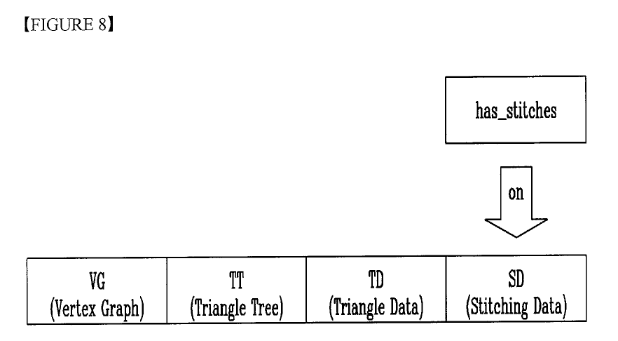

FIG. 8 illustrates an example of a 3DMC packet structure having added vertex/face stitching information according to the present invention. The structure of the 3DMC packet shown in FIG. 8 is known in the MPEG-4-SNHC. Accordingly, a detailed description for each field will be omitted and the fields added according to the present invention will be described.

Referring to FIG. 8, when an original model is a non-manifold model, a determination is made as to whether “Stitching Data (SD)” is inserted, based on a “has_stitches” flag.

The above-described packet structure is of illustrative purpose and the position of the vertex and face stitching information in the 3DMC packet may be changed. For example, in the above example, the vertex stitching information and face stitching information are inserted after the “Triangle Data (TD)”, but in another example, they may be inserted between the “Triangle Tree (TT)” and the “TD”.

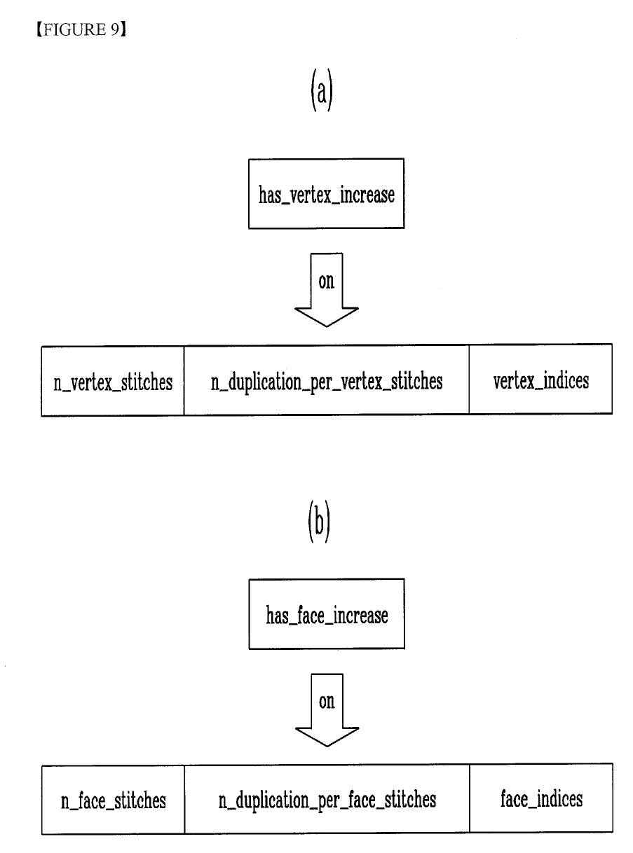

FIGS. 9A and 9B illustrate an example of syntax of vertex/face stitching information inserted into a packet according to the present invention.

Referring to FIG. 9A, the stitching information for the vertex is shown. If the “has_vertex_increase” flag indicating whether vertices are duplicated in the encoding process is on, a total number of duplicated original vertices, n_vertex_stitches, is inserted into the packet and a total number of the duplicated vertices for each original vertex (or a total number of the duplicated vertices plus one), n_duplication_per_vertex_stitches, is inserted into the packet. The identification information of the n_duplication_per_vertex_stitches number of the original vertices and the duplicated vertices are then inserted into the packet.

Referring to FIG. 9B, the stitching information for the face is shown. When the “has_face_increase” flag indicating whether the faces are duplicated in the encoding process is on, a total number of the duplicated original faces, n_vertex_stitches, is inserted into a packet, and a total number of the duplicated faces for each original face (or a total number of the duplicated faces plus one), n_duplication_per_face_stitches, is inserted into the packet. The n_duplication_per_face_stitches number of identification information of the original vertices and duplicated vertices are then inserted into the packet.

In the above example, since the vertices are duplicated, the has_vertex_increase set to on will be inserted into the packet, and since the duplicated original vertices are 7 and 11, the n_vertex_stitches will be set to 2. Since the duplicated vertex of the first original vertex 7 is “10”, the n_duplication_per_vertex_stitches is set to 1 (or 2), and identification information 7 and 10 are inserted. Since the duplicated vertex of the original vertex 2 is “11”, the n_duplication_per_vertex_stitches is set to 1 (or 2), and the identification information 2 and 11 are then inserted.

In the above example, the 1-bit flags, has_vertex_increase and has_face_increase, are used which indicate whether the vertex stitching information and the face stitching information are included. In another example, the following 2-bit has_vertex_face_increase flag may be used:

TABLE 1

| has_vertex_face_increase | Meaning |
|---|---|
| 00 | No added vertex/face |
| 01 | Only stitching information for face |
| 10 | Only stitching information for vertex |
| 11 | Stitching information for both vertex |
| | and face |

The present invention described above may be provided as a computer program stored on one or more computer-readable medium. The computer-readable medium may be a floppy disk, a hard disk, a CD ROM, a flash memory card, a PROM, a RAM, a ROM, or a magnetic tape. Generally, the computer program may be written in any programming language.

While the invention has been shown and described with reference to certain exemplary embodiments thereof, it will be understood by those skilled in the art that various changes in form and details may be made therein without departing from the spirit and scope of the invention as defined by the appended claims.

1. A method of encoding three-dimensional (3D) mesh information, comprising the steps of:
encoding the 3D mesh information to output an encoded bitstream;
encoding stitching information of elements contained in the 3D mesh information, the stitching information having a total number of duplicated original elements and, for each of the duplicated original elements, the duplication number, original-element identification information and duplicated-element identification information; and
generating a packet of the bitstream, wherein the encoded stitching information is inserted into the packet.

2. The method of encoding 3D mesh information according to claim 1, wherein the stitching information is at least one of vertex stitching information and face stitching information.

3. The method of encoding 3D mesh information according to claim 1, wherein the step of encoding the stitching information comprises the steps of:
(i) setting a bit number used to encode the stitching information to ┌log₂ N┐ (where, N is a total number of elements including duplicated elements);
(ii) encoding the total number of the duplicated original elements with the bit number; and
(iii) encoding, for each of the duplicated original elements, the duplication number plus one, the original-element identification information and the duplicated-element identification information with the bit number.

4. The method of encoding 3D mesh information according to claim 1, wherein the step of encoding the stitching information comprises the steps of:
(i) setting a bit number used to encode the stitching information to ┌log₂ N┐ (where, N is a total number of elements including the duplicated elements);
(ii) encoding the total number of the duplicated original elements with the bit number; and
(iii) encoding, for each of the duplicated original elements, the duplication number, the original-element identification information and the duplicated-element identification information with the bit number.

5. A method of encoding stitching information generated during a non-manifold model data encoding process by converting the non-manifold model to manifold models, the method comprising the steps of:
(i) setting a bit number used to encode the stitching information to ┌log₂ N┐ (where, N is a total number of elements including duplicated elements);
(ii) encoding the total number of duplicated original elements with the bit number; and
(iii) encoding, for each of the duplicated original elements, the duplication number plus one, original-element identification information, and duplicated-element identification information with the bit number.

6. An apparatus for encoding 3D mesh information, comprising:
means for encoding the 3D mesh information to output an encoded bitstream;
means for encoding stitching information of elements contained in the 3D mesh information, the stitching information having a total number of duplicated original elements and, for each of the duplicated original elements, the duplication number, original-element identification information and duplicated-element identification information; and
means for generating a packet of the bitstream, wherein the encoded stitching information is inserted into the packet.

7. The apparatus for encoding 3D mesh information according to claim 6, wherein the stitching information of elements contained in the 3D mesh information is at least one of vertex stitching information and face stitching information.

8. An apparatus for encoding stitching information generated during a non-manifold model data encoding process by converting a non-manifold model to manifold models, the apparatus comprising:
means for encoding the total number of duplicated original elements with a bit number ┌log₂ N┐ (where, N is a total number of elements including the duplicated elements); and
means for encoding, for each of the duplicated original elements, the duplication number plus one, original-element identification information and duplicated-element identification information with the bit number [log₂ N].

9. A computer-readable recording medium having a computer program recorded thereon for performing the method of encoding 3D mesh information according to any one of claims 1 to 4.

10. A computer-readable recording medium having a computer program recorded thereon for performing the method of encoding stitching information according to claim 5.

11. A method of decoding 3D mesh information, comprising the steps of:
decoding a 3D mesh information packet to reconstruct original model data;
determining whether the packet includes stitching information;
if it is determined that the packet includes the stitching information, extracting the stitching information from the packet and decoding the stitching information, the decoded stitching information having a total number of duplicated original elements and, for each of the duplicated original elements, the duplication number, original-element identification information and duplicated-element identification information; and
restoring an original non-manifold model based on the reconstructed original model data and the decoded stitching information.

12. The method of decoding 3D mesh information according to claim 11, wherein the stitching information is at least one of vertex stitching information and face stitching information.

13. The method of decoding 3D mesh information according to claim 11, wherein the step of determining whether the packet includes stitching information uses a flag value indicating whether the stitching information is included in a prescribed area of a header of the packet.

14. The method of decoding 3D mesh information according to claim 11, wherein the step of restoring an original non-manifold model based on the reconstructed original model data and the decoded stitching information comprises the steps of:
(i) deleting the duplicated element information from the reconstructed original model data; and
(ii) replacing the deleted duplicated element information with corresponding original element information.

15. The method of decoding 3D mesh information according to claim 14, wherein the step of restoring an original non-manifold model based on the reconstructed original model data and the decoded stitching information further comprises the step of: when identification information of each element is changed due to the deleted duplicated element information, reconstructing the 3D mesh information by reflecting this change.

16. The method of decoding 3D mesh information according to claim 11, wherein the step of decoding the stitching information comprises the steps of:
(i) reading a codeword with a bit number ┌log₂N┐ (where, N is a total number of elements including the duplicated elements) to decode a total number of duplicated original elements;
(ii) reading a next codeword with the bit number ┌log₂ N┐ to decode a duplication number plus one for a duplicated original element;
(iii) sequentially reading subsequent codewords with the bit number ┌log₂ N┐ to decode as many as the duplication number plus one of the original-element identification information and duplicated-element identification information; and
(iv) repeatedly performing steps (ii) and (iii) until all the stitching information for the duplicated original elements are decoded.

17. An apparatus for decoding 3D mesh information, comprising:
means for decoding a 3D mesh information packet to reconstruct original model data;
means for extracting the stitching information from the packet and decoding the stitching information, the decoded stitching information having a total number of duplicated original elements and, for each of the duplicated original elements, the duplication number, original-element identification information and duplicated-element identification information; and
means for restoring an original non-manifold model based on the reconstructed original model data and the decoded stitching information.

18. The apparatus for decoding 3D mesh information according to claim 17, wherein the means for restoring an original non-manifold model based on the reconstructed original model data and the decoded stitching information deletes the duplicated element information from the reconstructed original model data, and replaces the deleted duplicated element information with corresponding original element information.

19. A computer-readable recording medium having a computer program recorded thereon for performing the method of decoding 3D mesh information according to any one of claims 11 to 16.
